(19) United States
(12) Patent Application Publication
(10) Pub. No.: US 2023/0187991 A1
(43) Pub. Date: Jun. 15, 2023

(54) SYSTEMS FOR HAIRPIN WIRES FOR ELECTRIC MOTORS

(71) Applicant: Dana Automotive Systems Group, LLC, Maumee, OH (US)

(72) Inventors: Joachim DRUANT, Houthulst (BE); Steven VANHEE, Hooglede (BE)

(21) Appl. No.: 17/643,576

(22) Filed: Dec. 9, 2021

(51) Int. Cl. H02K 3/28

(52) U.S. Cl. CPC H02K 3/28

(57) ABSTRACT

Systems are provided for stator slots with multiple rectangular layers of differing widths. In one example, a system may include a stator including a plurality of segmented slots included around an inner circumference of the stator. Each segmented slot may contain within it legs of hairpin wires, the legs within each slot including differing widths.

### TECHNICAL FIELD

The present description relates generally to systems for electric motors including hairpin wires with varying widths.

### BACKGROUND AND SUMMARY

In automotive applications, an electric motor is used for multiple purposes such as a starter motor, an electric drive assist (propulsion boost) as well as pure electric drive, a generator providing electric power for onboard electric loads and charging the battery banks, and as a re-generator acting to convert the kinetic energy of the vehicle to electric power for charging the battery bank during braking/deceleration of the vehicle.

The electric motor may include a stator and a rotor, with the rotor coupled to one or more output shafts. The stator may be stationary, and may be electrically powered by a voltage source (such as a battery) to generate currents in a plurality of conducting wires included within a core of the stator (referred to herein as the stator core), which may then generate magnetic fields. In one example, the magnetic fields generated by the stator may induce a current within the rotor, causing the rotor to rotate in response to the combined magnetic fields of the stator and rotor. In another example, the rotor may contain permanent magnets, which may cause the rotor to rotate in response to the magnetic fields generated by the stator. The rotational motion of the rotor may then translate into a rotation of one or more output shafts coupled to the rotor of the electric motor.

The plurality of conducting wires may be inserted into slots (referred to herein as stator slots) within the stator core. The stator slots may be configured as cutouts that extend radially through part of a thickness of the stator core, and extend fully through a length of the stator core. The stator slots may be arranged evenly spaced along a circumference of the stator core, and pairs of adjacent stator slots may be separated by stator teeth. The magnetic field generated within the stator may be adjusted based on the shape and dimensions of the stator slots, and the shape and dimensions of the conducting wires included therein, and the resistance (and corresponding copper losses) of the plurality of conducting wires may vary.

In one example, each slot of the stator core may be trapezoidal in shape, with each stator slot including a plurality of round conducting wires inserted into the stator slot, the plurality of round conducting wires filling the slot with a certain filling factor. Additionally, adjacent flanks of adjacent trapezoidal stator slots may be parallel to each other, or in other words, each stator tooth between adjacent stator slots may be rectangular, and as such may include flanks that are parallel along the radial direction. By including stator teeth with parallel flanks, a constant magnetic flux density may be maintained radially along the stator teeth, leading to increased efficiency of the electric motor.

In another example, each slot of the stator core may be rectangular in shape, and may include legs of hairpin conducting wires, the legs of the hairpin conducting wires having rectangular cross sections, inserted into the stator slot. By utilizing rectangular stator slots with hairpin wires inserted therein, a higher filling factor can be achieved for the stator slots as compared to trapezoidal stator slots with round conducting wires inserted therein.

However, each of the above examples may have potential issues. While the example including trapezoidal slots with round conducting wires inserted therein may allow for generation of a constant magnetic flux density within the stator teeth, the filling factor for round wires within the stator slots is lower than for rectangular hairpin wires within a rectangular stator slot, thereby leading to reduced power density of the electric motor. Further, the insertion of round conducting wires to the stator slots may be difficult to automate, and the round conducting wire geometry may lead to large DC resistance. In contrast, while the example of rectangular conducting hairpin wires in rectangular stator slots may include more favorable filling factors, reduced DC resistance, and may allow for easier insertion of the conductive wires into the stator core as compared to the previous example, the stator teeth between adjacent stator slots may include flanks that diverge radially along the stator core (e.g. the stator teeth may be of a trapezoidal shape), leading to a decreasing magnetic flux density in the radial direction. Further, the rectangular stator slots may have a reduced area as compared to the trapezoidal slots, leading to higher copper losses, and hence reduced electric motor efficiency. Additionally, the greater cross-sectional area of the rectangular hairpin wires as compared to the round wires may lead to increased AC copper losses due to the proximity effect.

Attempts have been made to modify the design of hairpin wires in rectangular slots. One example approach is given by Jeong Dae-sung in K.R. 1020120131309A. Therein, Dae-sung proposes including rectangular conducting hairpin wires, where the legs of the hairpin wires include a plurality of conducting layers therein, with each conducting layer separated by an insulating layer. In this way, AC copper losses may be reduced as compared to e.g. traditional rectangular hairpin wires within a rectangular stator slot, while an increased filling factor may be maintained as compared to e.g. a plurality of thin, round wires within a trapezoidal stator slot, thereby increasing electric motor power and efficiency.

However, the inventors herein have recognized potential issues with such systems. As one example, the system of K.R. 1020120131309A has trapezoidal stator teeth (e.g. the flanks of the stator tooth diverge from each other with increasing radial distance), resulting in a radially decreasing magnetic flux density within the stator teeth. Additionally, by utilizing rectangular stator slots, the stator slot area is reduced as compared to a trapezoidal stator slot.

In one example, the issues described above may be addressed by a system for a stator assembly of an electric motor, comprising a plurality of segmented slots positioned around an inner cylindrical surface of the stator, and a plurality of hairpin wires of different widths stacked within each of the segmented slots. In this way, by including hairpin wires with different widths approximating a trapezoidal stator slot, an approximately constant magnetic flux density may be maintained within the stator teeth, while maintaining a low DC resistance and large filling factor.

As one example, stator slots of the stator may include four contiguous rectangular layers, with increasing width for each subsequent layer in the radial direction. Correspondingly, each stator slot may include a first pair of hairpin wire legs with a first width in a first layer of the stator slot, a second pair of hairpin wire legs stacked radially beyond the first pair in a second layer of the stator slot with a second, greater width, a third pair of hairpin wire legs stacked radially beyond the second pair in a third layer of the stator slot with a third, greater width, and a fourth pair of hairpin wire legs stacked radially beyond the third pair in a fourth layer of the stator slot with a fourth, greater width.

In this way, by using pairs of hairpin wire legs in each stator slot, the pairs each having different widths, an electric motor may achieve the same filling factor as with rectangular hairpin legs in a rectangular slot, but may have an increased slot area as compared to the rectangular stator slot. The technical effect of having multiple layers of hairpin wire legs with increasing widths in the radial direction is that the magnetic flux density within stator teeth may be maintained substantially constant, due to the flanks of the stator teeth being substantially parallel. Further, the stator design including slots with increasing width along the radial direction may have reduced DC resistance as compared to each of a rectangular slot design with the same filling factor and a trapezoidal slot design including round wires. By reducing DC resistance, motor efficiency may be increased as compared to previous stator slot designs.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a first end view of an electric motor.

FIG. 2 shows a second end view of an electric motor, including detail of slots included in a stator housing.

FIG. 3A shows a first embodiment of a hairpin wire with a first width.

FIG. 3B shows a second embodiment of a hairpin wire with a second width.

FIG. 3C shows a third embodiment of a hairpin wire with a third width.

FIG. 3D shows a fourth embodiment of a hairpin wire with a fourth width.

FIG. 4A shows a first embodiment of a stator slot, including four pairs of hairpin wires therein.

FIG. 4B shows a second embodiment of a stator slot with four sections of varying widths, including four pairs of hairpin wires of varying widths therein.

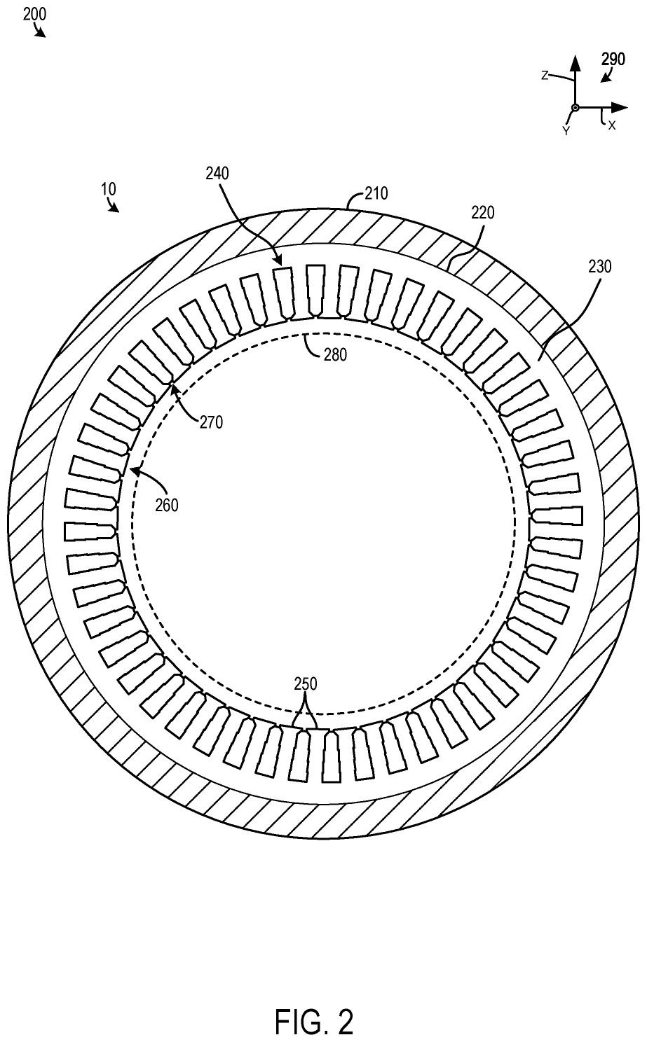

FIGS. 2-4B are shown approximately to scale.

### DETAILED DESCRIPTION

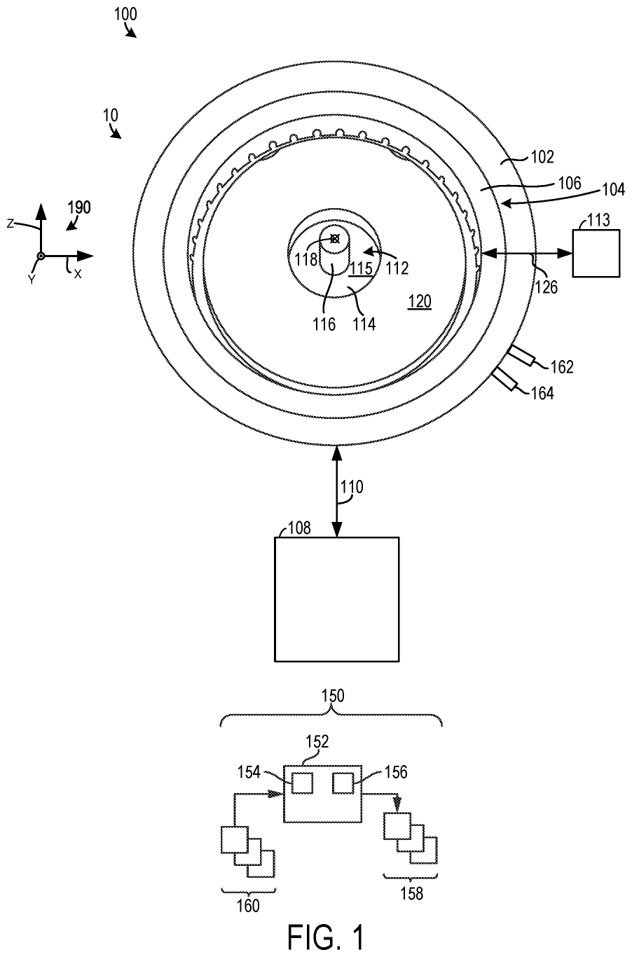

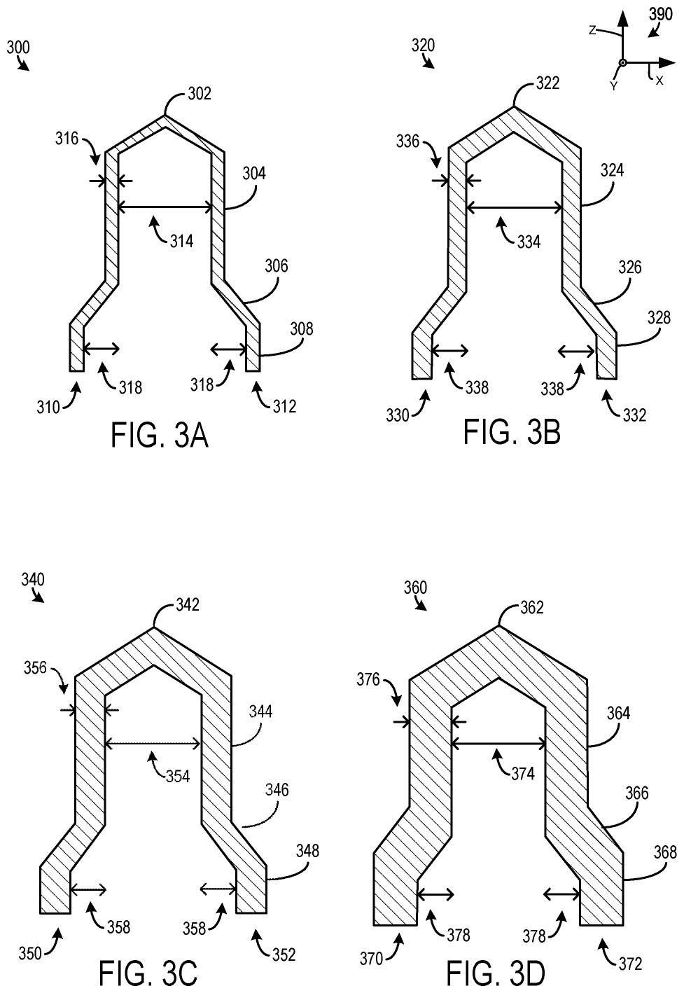

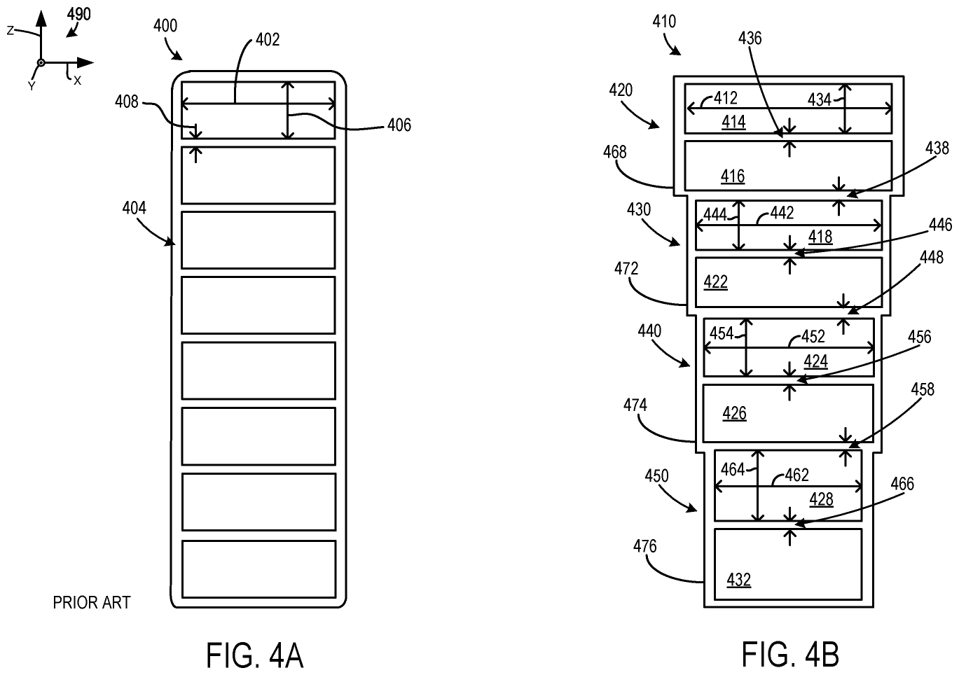

The following description relates to systems for including multiple layers of hairpin wires of differing widths within a single stator slot. The stator slots may be formed within a stator of an electric motor; an embodiment of an electric motor is given in FIG. 1. A corresponding end view of the electric motor of FIG. 1, including detail of the stator slots, is given in FIG. 2. The stator slots of FIG. 2 include four contiguous rectangular layers, with the width of the rectangular layers increasing in a radial direction. Correspondingly, the layers within the stator slots may be filled with pairs of legs of conducting hairpin wires, the widths of the legs of the hairpin wires corresponding to the widths of the layers. FIGS. 3A-D show planar views of four different hairpin wire designs with varying widths of the hairpin legs. FIG. 4A shows a first filled rectangular stator slot including eight hairpin legs of equal area and equal aspect ratio (a ratio of a first extent of an object in one direction to a second extent of the object in a perpendicular direction, e.g., a ratio of a width of a layer of a slot to a height of the layer in a radial direction), while FIG. 4B shows a second filled stator slot with four pairs of hairpin legs, with each pair of hairpin legs having equal cross-sectional area, but having differing widths.

FIG. 1 shows a first end view 100 of an electric motor 10. The electric motor 10 includes a housing 102 that encloses internal components. A stator 104 including a first end winding 106 may be enclosed via the housing 102. The end winding 106 may include a plurality of wound or hairpin wires (e.g., round wires, rectangular wires, flat wires, etc.) which are outside a core of the stator 104. The wound or hairpin wires may be connected to an input voltage source via a phase bus bar 113, with a coupling to the hairpin wires housed in the end winding 106 indicated by arrow 126. However, it will be appreciated that the stator core also includes wire sections which extend therethrough. Further, the stator 104 may receive electrical energy from an energy storage device 108 (e.g., battery, capacitor, and the like) and in some cases, such as when the motor is designed with regeneration functionality, transfer electrical energy to the energy storage device 108. Arrow 110 denotes this energy transfer. The electric motor further includes a rotor 112 with a core 114 a rotor shaft 116 rotating about rotational axis 118. It will be understood that a radial direction is any direction perpendicular to the rotational axis 118. Additionally, an axis system 190 including an x-axis, y-axis, and z-axis is also provided, for reference. The z-axis may be a vertical axis, the x-axis may be a lateral axis, and/or the y-axis may be a longitudinal axis, in one example. However, the axes may have other orientations, in other examples. It will be appreciated that the electric motor may be designed to generate rotational output in a first rotational direction and, in certain examples, a second rotational direction. Further, in some examples, the electric motor may be designed to operate in a regeneration mode where the motor receives rotational input and generates electrical energy responsive to receiving the rotational input.

The rotor core 114 may include a plurality of metal laminations 115 (e.g., laminated magnetic steel or iron) or a solid magnetic metal. Thus, the rotor core 114 includes a magnetically interactive portion (e.g., permanent magnet or electromagnet). It will be appreciated that during motor operation the rotor 112 may rotate while the stator 104 is held relatively stationary.

The stator 104 and the rotor 112 are configured to electrically interact to generate a rotational output and, in some cases, generate electrical energy responsive to receiving a rotational input from an external source such as a vehicle gear-train, in one use-case example. However, as mentioned above, the motor may be used in wide variety of operating environments. As such, the electric motor 10 is configured to generate rotational output and, in some examples, in a regeneration mode, receive rotational input and generate electrical energy output. Thus, the electric motor 10 may be designed to receive electrical energy from the energy storage device 108 and, in some examples, transfer energy to the energy storage device. Wired and/or wireless energy transfer mechanisms may be used to facilitate this energy transfer functionality.

A first balancing plate 120 is shown attached to the rotor core 114. The balancing plate 120 may be designed to account for imbalances in the rotor 112. To elaborate, the mass and mass distribution of the first balancing plate 120 and a second balancing plate, may be selected to counterbalance residual unbalanced forces in the motor. In other words, the balancing plates may provide cooling airflow dynamics, as well as substantial counterbalance functionality, in one example.

The electric motor 10 may be coupled to a control system 150 with a controller 152. The controller 152 includes a processor 154 (e.g., a microprocessor unit and/or other types of circuits) and memory 156 (e.g., random access memory, read only memory, keep alive memory, combinations thereof, etc.). The controller 152 may be configured to send control commands to system components 158 as well as receive signals from sensors 160 and other suitable components. The controllable components may include the electric motor 10 (e.g., the motor's stator). It will be understood that the controllable components may include actuators to enable the component adjustment. The sensors may include a motor temperature sensor 162, a rotor position sensor 164, etc. As such, the controller 152 may receive a signal indicative of the motor's speed and adjust the output of the motor based on the speed signal. The other controllable components in the electric motor may function in a similar manner. Furthermore, it will be understood that the controller 152 may send and receive signals via wired and/or wireless communication.

FIG. 2 shows a second end view 200 of an electric motor 10. The electric motor 10 may be the same or significantly similar to the electric motor 10 of FIG. 1. An axis system 290 including an x-axis, y-axis, and z-axis is provided, for reference. The axis system 290 may be the same as the axis system 190 of FIG. 1. The z-axis may be a vertical axis, the x-axis may be a lateral axis, and/or the y-axis may be a longitudinal axis, in one example. However, the axes may have other orientations, in other examples. The second end view 200 may be a cross-sectional view of the electric motor 10 defined in the x-z plane of the axis system 290 perpendicular to an axis of rotation of the electric motor 10. The axis of rotation of the motor may be parallel to the y-axis of axis system 290, and may be the same as the rotational axis 118 of FIG. 1.

The electric motor 10 is enclosed in a circumferential motor housing 210. The circumferential motor housing 210 may be the same as the motor housing 102 of FIG. 1. Concentrically arranged within the motor housing 210 is the stator 220, including an annular stator core 230. The stator 220 may be the same as stator 104 of FIG. 1. The stator core 230 may include a plurality of stator teeth 250 on an inner circumference 260 of the stator core. The plurality of stator teeth 250 may be evenly spaced along an inner circumference 260 of the stator core 230, and may separate adjacent stator slots 270 of a plurality of stator slots 240. In the embodiment of the electric motor 10 shown in FIG. 2, the plurality of stator slots 240 includes 48 stator slots, and consequently the plurality of stator teeth 250 includes 48 stator teeth; however, other embodiments including a different number of stator teeth and stator slots may be possible. Each stator slot 270 may be a radial cutout from the stator core 230. Each stator slot 270 may include four rectangular layers contiguously connected to each other in an approximate trapezoidal shape, with a width (an extent of a layer in a direction tangential to radial direction of the cutout) of each subsequent layer in the radial direction being greater than the previous layer. In other words, a first layer of a stator slot, the first layer closest to the inner circumference 260 of the stator core 230, may have a smaller width than the second adjacent layer of the stator slot (e.g., the first layer may be longer in the radial direction than the second layer), and so on. In some embodiments, a cross-sectional area of each of the layers of the stator slot may be the same; however, such embodiments should be taken as non-limiting, and the cross-sectional area may of each of the layers may vary based on design specifications. In other example embodiments of the electric motor of FIG. 2, a different number of layers within each stator slot 270 may be included. Each layer of each of the stator slot 270 may include a pair of legs of hairpin wires (not shown) threaded through the stator slot. Further details of stator slots as hairpin wires included therein is provided in relation to FIG. 4B. Placed concentrically within the stator core 230 is a rotor 280, which may rotate with respect to the stator 220 in response to magnetic fields generated within the stator. The rotor 280 may be the same as rotor 112 of FIG. 1. An air gap may separate the stator 220 and the rotor 280, allowing relative motion between the two. Said another way, the fourth layer may be proximal to the rotor 280 of the electric motor 10, with the third layer being adjacent to the fourth layer, the second layer being adjacent to the third layer, and the first layer being adjacent to the second layer.

In this way, FIG. 2 may provide a system for conductive windings for the stator 220 of the electric motor 10, comprising the plurality of stator slots 240 evenly spaced circumferentially around an inner cylindrical surface (e.g. inner circumference 260), with each slot 270 of the plurality of stator slots 240 diverging from the inner cylindrical surface of the stator 220 towards an outer cylindrical surface of the stator, and conductive windings of varying width inserted within each slot 270 of the plurality of slots 240. Within the system, each slot 270 may include four sets of conductive windings, with widths of the conductive windings increasing from a first end of the slot proximal to the inner cylindrical surface of the stator 220 towards a second end of the radial slot proximal to the outer cylindrical surface of the stator, with each set of conductive windings including two conductive windings of the same dimensions.

Conductive windings for a stator (such as stator 104 of FIG. 1 and stator 220 of FIG. 2) are provided by hairpin wires. FIGS. 3A-D show a planar view of example hairpin wires. The planar view of the example hairpin wires may be taken in an x-z plane of an axis system 390. The hairpin wires as embodied in FIGS. 3A-D may have differing leg widths.

FIG. 3A shows a first example of a hairpin wire 300. The hairpin wire 300 may be a U-shaped segment of conductive wire (such as copper), joined together at one end (e.g. the turn-end) by an end turn 302. A U-shape of the hairpin wire 300 may include two legs extending outward from a common connection point (the end turn 302), whereby the hairpin wire 300 defines a concave shape in the x-z plane (e.g., concave down with respect to the z-axis of axis system 390), and whereby leg ends 308 of the legs 310, 312 are parallel to each other, and to e.g. the z-axis. The other ends (e.g. connection ends) of the legs 310, 312 of hairpin wire 300 are spaced apart from each other. Each of the two legs 310, 312 includes a straight segment 304 extending from the end turn 302, a bent segment 306, and the straight leg end 308. During stator assembly, the legs 310, 312, while they are still straight, are inserted into a stator (such as stator 104 of FIG. 1 and stator 220 of FIG. 2) into respective slots from the insertion side of the stator (e.g., the insertion side being the same as the side of the electric motor as the as the first end view 100 of the electric motor 10 of FIG. 1 and the second end view 200 of the electric motor 10 of FIG. 2). The legs 310, 312 may extend through the stator with straight leg ends 308 extending past the connection side of the stator body. The straight leg ends 308 on the connection side of the stator may then be bent outward, in order to form electrical connections between hairpin wires. The hairpin wire 300 may include a spacing between the straight segments 304 of the legs 310, 312 of the hairpin wire, the spacing being of a first span 314. The first span 314 may be then equal to a distance between stator slots (such as stator slots of the plurality of stator slots 240 of FIG. 2) each leg of the hairpin wire 300 is inserted in. The legs 310, 312 of the hairpin wire 300 each include the bent segment 306 which is bent with the same second span 318, the second span 318 extending outward from the end turn 302. Wave windings may be formed by serially connecting alternating multiple hairpins wires together at their respective connecting ends.

FIG. 3B shows a second example of a hairpin wire 320. The respective legs of hairpin wires 300, 320, may have different widths (where the width of a leg of a hairpin wire may be defined here as a thickness of the leg along the x-axis (e.g., width 336 of legs 330, 332)), but may otherwise be of the same design. In particular, the hairpin wire 320 may include an end turn 322, two legs 330, 332, each leg including a straight segment 324 extending from the end turn 322, a bent segment 326, and a straight leg end 328. Additionally, a first span 334 between legs 330, 332 may be slightly larger than the first span 314 between legs 310, 312 of FIG. 3A, the increase in span owing to the increased separation between layers in adjacent slots along the radial direction. Similarly, a second span 338 of each of the legs 330, 332 may be the same as the second span 318 of legs 310, 312 of FIG. 3A. In the planar view of the of the hairpin wires 300, 320 depicted in FIGS. 3A, and 3B, respectively, this corresponds to the width 336 of the legs 330, 332 of the hairpin wire 320 being greater than the width 316 of the legs 310, 312 of the hairpin wire 300 of FIG. 3A.

FIG. 3C shows a third example of a hairpin wire 340. Each of the hairpin wires 300, 320, 340 may have different leg widths, but may otherwise be of the same design. In particular, the hairpin wire 340 may include an end turn 342, two legs 350, 352, each leg including a straight segment 344 extending from the end turn 342, a bent segment 346, and a straight leg end 348. Additionally, a first span 354 between legs 350, 352 may be slightly larger than the first span 334 between legs 330, 332 of FIG. 3B, the increase in span owing to the increased separation between layers in adjacent slots along the radial direction. In the planar view of the of the hairpin wires 300, 320, 340 depicted in FIGS. 3A, 3B, and 3C, respectively, this corresponds to the width 356 of the legs 350, 352 of the hairpin wire 340 being greater each of the width 316 of the legs 310, 312 of the hairpin wire 300 of FIG. 3A, and the width 336 of the legs 330, 332 of the hairpin wire 320 of FIG. 3B.

FIG. 3D shows a fourth example hairpin wire 360. Each of the hairpin wires 300, 320, 340, 360 may have different leg widths, but may otherwise be of the same design. In particular, the hairpin wire 360 may include an end turn 362, two legs 370, 372, each leg including a straight segment 364 extending from the end turn 362, a bent segment 366, and a straight leg end 368. Additionally, a first span 374 between legs 370, 372 may be slightly larger than the first span 354 between legs 350, 352 of FIG. 3C, the increase in span owing to the increased separation between layers in adjacent slots along the radial direction. In the planar view of the of the hairpin wires 300, 320, 340 360 depicted in FIGS. 3A, 3B, 3C, and 3D, respectively, this corresponds to the width 376 of the legs 370, 372 of the hairpin wire 360 being greater each of the width 316 of the legs 310, 312 of the hairpin wire 300 of FIG. 3A, the width 336 of the legs 330, 332 of the hairpin wire 320 of FIG. 3B, and the width 356 of the legs 350, 352 of the hairpin wire 340 of FIG. 3C.

The hairpin wires 300, 320, 340, 360 of FIGS. 3A, 3B, 3C, and 3D, respectively may then be inserted into stator slots (such as stator slots 270 of FIG. 2) of a stator (such as stator 220 of FIG. 2) and connected serially at a connection end of the stator in order to form a set of stator windings. The stator windings may then comprise one or more phases of an electric motor (such as electric motor 10 of FIGS. 1-2).

The hairpin wires depicted in FIGS. 3A-D may be included within stator slots of an electric motor (such as electric motor 10 of FIG. 1). FIGS. 4A-4B show embodiments of stator slots, including a first embodiment of a rectangular stator slot 400 and a second embodiment of a segmented stator slot 410, the segmented stator slot 410 including four rectangular layers of differing width. Included in FIGS. 4A-B is an axis system 490, the axis system 490 being the same as axis system 290 of FIG. 2 and axis system 190 of FIG. 1. The stator slots 400, 410 are shown from an end view of a stator (such as stators 104, 220 of FIGS. 1, 2, respectively) of an electric motor (such as electric motor 10 of FIGS. 1, 2), the end view being in a plane perpendicular to the x-z plane of axis system 490, which may be a plane perpendicular to an axis of rotation (such as rotational axis 118 of FIG. 1) of the electric motor.

In particular, FIG. 4A shows the rectangular stator slot 400, the rectangular stator slot 400 including a plurality of rectangular hairpin wire legs 404. The rectangular stator slot 400 may be a common design that is well known to those versed in the art. Each rectangular hairpin wire leg of the plurality of rectangular hairpin wire legs 404 may have equal cross-sectional area, and in particular, may have the same height 406 and width 402. Additionally, adjacent rectangular hairpin wire legs of the plurality of rectangular hairpin wire legs 404 may have the same spacing 408 between them. In one example, the corners formed between edges of the legs of the hairpin wires may be chamfered in order to prevent damaging of an insulating liner (not shown) within the rectangular stator slot 400. The plurality of rectangular hairpin wire legs 404 may fill the rectangular stator slot 400 with a given filling factor. The filling factor is the ratio of the total cross-sectional area of the plurality of rectangular hairpin wire legs 404 to the total cross-sectional area of the rectangular stator slot 400.

FIG. 4B shows the segmented stator slot 410 including four rectangular layers with equal cross-sectional area but with differing widths, the segmented stator slot 410 included as cutouts from a stator (such as stator 104 of FIG. 1 and stator 220 of FIG. 2) in an electric motor (such as electric motor 10 of FIGS. 1-2). The segmented stator slot 410 may be segmented in shape in such a manner as to approximate a trapezoidal slot, with widths of each layer of the slot diverging from a first end proximal to a rotor (such as rotor 280 of FIG. 2) to a second end proximal to a motor housing (such as motor housing 210 of FIG. 2) of the electric motor. The segmented stator slot 410 includes two or more layers, with each layer housing one or more legs of one or more corresponding hairpin wires. In the embodiment depicted in FIG. 4B, the segmented stator slot 410 includes a first layer 476, the first layer being closest of the four layers of the stator slot to an inner circumference (such as the inner circumference 260 of FIG. 2) of the stator. In the embodiment depicted in FIG. 4B, each of the first layer 476, the second layer 474, the third layer 472, and the fourth layer 468 may house two legs of two corresponding hairpin wires, where the cross-sectional area of each of the legs of the pairs of hairpin wires may be the same, and may be the same as the cross-sectional area of each of the plurality of hairpin wires 404 of FIG. 4A. However, this embodiment may be taken as non-limiting, and in other embodiments, the cross-sectional area of the each of the legs of the pairs of the hairpin wires may vary according to the layer, depending on the design specifications. In particular, the first layer 476 includes within it a first pair 450 of rectangular hairpin wire legs, with each leg 432, 428 of the first pair 450 of hairpin wire legs belonging to separate hairpin wires. The first leg 432 may be closer to the inner circumference of the stator than the second leg 428, the second leg 428 being placed adjacent and past the first leg 432 in a radial direction (e.g., a direction extending along a length of the stator slot 410, the direction parallel to a positive z direction of the z axis of axis system 490) within the first layer 476 of the segmented stator slot 410. The first pair 450 of hairpin wire legs may have a first height 464 and first width 462, and may have the same or approximately the same (within 5%) aspect ratio as the first layer 476 of the stator slot, filling the stator slot with a given filling factor. Additionally, the first width 462 may be the substantially equal to the width 402 of each of the plurality of hairpin wire legs 404 of FIG. 4A. In one example, the filling factor of the first pair 450 of hairpin wire legs within the first layer 476 of the segmented stator slot 410 may be the same as the filling factor of the plurality of rectangular hairpin wire legs 404 within the rectangular stator slot 400 of FIG. 4A. Similarly as in FIG. 4A, each leg 432, 428 of the first pair 450 of hairpin wire legs may have chamfered corners, in order to reduce degradation of an insulating liner (not shown) within the segmented stator slot 410. Additionally, the inner edges of the first layer 476 of the segmented stator slot 410 may also have chamfered corners as well, in order to reduce degradation to the insulating liner within the segmented stator slot. The first pair 450 of hairpin wire legs may have a first separation 466 between the pair within the first layer 476.

Placed directly above (e.g., advanced in a positive z-direction along the z-axis of axis system 490) the first layer 476 of the segmented stator slot 410 is the second layer 474. The second layer 474 may be contiguously connected to the first layer 476, placed such that a middle of a width (e.g., an extent of the second layer 474 in a direction along the x-axis of axis system 490) of the second layer 474 may be aligned with a middle of a width of the first layer 476 along the radial direction. The cross-sectional area of the second layer 474 may be the same as the cross-sectional area of the first layer 476, but the aspect ratio of the second layer 474 may be greater than the aspect ratio of the first layer 476, such that the width of the second layer 474 extends beyond a width of the first layer, while a height (e.g., an extent of the second layer 474 in a direction along the z-axis of axis system 490) of the second layer 474 is less than a height of the first layer 476.

The second layer 474 includes within it a second pair 440 of rectangular hairpin wire legs, with each leg 426, 424 of the second pair 440 of hairpin wire legs coming from separate hairpin wires. A third leg 426 may be closer to the inner circumference of the stator than a fourth leg 424, the fourth leg 424 being placed adjacent and past the third leg 426 in the radial direction within the second layer 474 of the segmented stator slot 410. The second pair 440 of hairpin wire legs may have a given second height 454 and second width 452, and may have the same or approximately the same (within 5%) aspect ratio as the second layer 474 of the stator slot, filling the stator slot with a given filling factor. The filling factor of the second pair 440 of hairpin wire legs within the second layer 474 may be the same as the filling factor of the first pair 450 of hairpin wire legs within the first layer 476 of the segmented stator slot 410. Each leg 426, 424 of the second pair 440 of hairpin wire legs may have chamfered corners, in order to reduce degradation of the insulating liner (not shown) within the segmented stator slot 410. Additionally, the inner edges of the second layer 474 of the segmented stator slot 410 may also have chamfered corners as well, in order to reduce degradation to the insulating liner within the segmented stator slot. The second leg 428 and the third leg 426 may have a second separation 458 between them, and the second pair 440 of hairpin wire legs may have a third separation 456 between the second pair 440 of hairpin wire legs within the second layer 474, such that each leg 426, 424 of the second pair 440 of hairpin wire legs may be spaced evenly within the second layer 474 of the segmented stator slot 410.

Placed directly above (e.g., advanced in a positive z-direction along the z-axis of axis system 490) the second layer 474 of the segmented stator slot 410 is the third layer 472. The third layer 472 may be contiguously connected to the second layer 474, placed such that a middle of a width of the third layer 472 may be aligned with the middle of the width of the second layer 474 along the radial direction. The cross-sectional area of the third layer 472 may be the same as each of the cross-sectional areas of the second layer 474 and the first layer 476, but the aspect ratio of the third layer 472 may be greater than the aspect ratio of the second layer 474, such that the width of the third layer 472 extends beyond the width of the second layer, while a height of the third layer 472 is less than a height of the second layer 474.

The third layer 472 includes within it a third pair 430 of rectangular hairpin wire legs, with each leg 422, 418 of the third pair 430 of hairpin wire legs coming from separate hairpin wires. A fifth leg 422 may be closer to the inner circumference of the stator than a sixth leg 418, the sixth leg 418 being placed adjacent and past the fifth leg 422 in the radial direction within the third layer 472 of the segmented stator slot 410. The third pair 430 of hairpin wire legs may have a given third height 444 and third width 442, and may have the same or approximately the same (within 5%) aspect ratio as the third layer 472 of the stator slot, filling the stator slot with a given filling factor. The filling factor of the third pair 430 of hairpin wire legs within the third layer 472 may be the same as each of the filling factor of the second pair 440 of hairpin wire legs within the second layer 474, and the first pair 450 of hairpin wire legs within the first layer 476 of the segmented stator slot 410. Each leg 422, 418 of the third pair 430 of hairpin wire legs may have chamfered corners, in order to reduce degradation of the insulating liner (not shown) within the segmented stator slot 410. Additionally, the inner edges of the third layer 472 of the segmented stator slot 410 may also have chamfered corners as well, in order to reduce degradation to the insulating liner within the segmented stator slot. The fourth leg 424 and the fifth leg 422 may have a fourth separation 448 between them, and the third pair 430 of hairpin wire legs may have a fifth separation 446 between the third pair 430 of hairpin wire legs within the third layer 472, such that each leg 422, 418 of the third pair 430 of hairpin wire legs may be spaced evenly within the third layer 472 of the segmented stator slot 410. The fourth separation 448 and the second separation 458 may be sized such that the second pair 440 of hairpin wire legs may be placed evenly within the second layer 474.

Placed directly above (e.g., advanced in a positive z-direction along the z-axis of axis system 490) the third layer 472 of the segmented stator slot 410 is the fourth layer 468. The fourth layer 468 may be contiguously connected to the third layer 472, placed such that a middle of a width of the fourth layer 468 may be aligned with the middle of the width of the third layer 472 along the radial direction. The cross-sectional area of the fourth layer 468 may be the same as each of the cross-sectional areas of the third layer 472, the second layer 474, and the first layer 476, but the aspect ratio of the fourth layer 468 may be greater than the aspect ratio of the third layer, such that the width of the fourth layer extends beyond the width of the third layer, while a height of the fourth layer is less than a height of the third layer.

The fourth layer 468 includes within it a fourth pair 420 of rectangular hairpin wire legs, with each leg 416, 414 of the fourth pair 420 of rectangular hairpin wire legs coming from separate hairpin wires. A seventh leg 416 may be closer to the inner circumference of the stator than an eighth leg 414, the eighth leg 414 being placed adjacent and past the seventh leg 416 in the radial direction within the fourth layer 468 of the segmented stator slot 410. The fourth pair 420 of hairpin wire legs may have a given fourth height 434 and fourth width 412, and may have the same or approximately the same (within 5%) aspect ratio as the fourth layer 468 of the stator slot, filling the stator slot with a given filling factor. The filling factor of the fourth pair 420 of hairpin wire legs within the fourth layer 468 may be the same as each of the filling factor of the third pair 430 of hairpin wire legs within the third layer 472, the second pair 440 of hairpin wire legs within the second layer 474, and the first pair 450 of hairpin wire legs within the first layer 476 of the segmented stator slot 410. Each leg 416, 414 of the fourth pair 420 of hairpin wire legs may have chamfered corners, in order to reduce degradation of the insulating liner (not shown) within the segmented stator slot 410. Additionally, the inner edges of the fourth layer 468 of the segmented stator slot 410 may also have chamfered corners as well, in order to reduce degradation to the insulating liner within the segmented stator slot. The sixth leg 418 and the seventh leg 416 may have a sixth separation 438 between them, and the fourth pair 420 of hairpin wire legs may have a seventh separation 436 between the fourth pair 420 of hairpin wire legs within the fourth layer 468, such that each leg 416, 414 of the fourth pair 420 of hairpin wire legs may be spaced evenly within the fourth layer 468 of the segmented stator slot 410. The fourth separation 448 and the sixth separation 438 may be sized such that the third pair 430 of hairpin wire legs may be placed evenly within the third layer 472.

The aspect ratios of each of the pairs 450, 440, 430, 420 of legs may be selected in order to satisfy certain design criteria of the electric motor. For example, the freedom to select the aspect ratios of each of the pairs 450, 440, 430, 420 of legs may be used to reduce electrical losses associated with the skin & proximity effects. The aspect ratios of hairpin wire legs closer to the inner circumference of the stator may be made smaller, while wires cross sections further from the inner circumference of the stator could be made larger. In this way, total copper losses (AC loss included) at high frequencies may be reduced. This degree of freedom in design specification of the stator slots may also be an additional advantage as compared to a conventional hairpin winding.

In this way, the segmented stator slot 410 of FIG. 4B illustrates a system for housing conductive windings within the stator of the electric motor, the system comprising a first set of conductive windings (e.g., comprised of hairpin wires) of a first width inserted within the first layer 476 of the segmented stator slot 410 positioned along an inner surface the stator, and a second set of conductive windings of a second width inserted within the second layer 474 of the segmented stator slot, the second width greater than the first width. The system may further include a third set of conductive windings of a third width inserted within the third layer 472 of the slot positioned adjacent to the second layer 474, and a fourth set of conductive windings of a fourth width inserted within the fourth layer 468 of the slot positioned adjacent to the third layer 472, the third width greater than the second width and the fourth width greater than the third width. Each of the first set, the second set, the third set, and the fourth set of conductive windings may include one leg each of corresponding two conductive windings of a same width. Legs of conductive windings within corresponding layers of the segmented stator slot 410 may have substantially equal (e.g., within 5%) widths as the corresponding layers, such that the first width may be substantially equal to a fifth width of the first layer 476, the second width may be substantially equal to a sixth width of the second layer 474, the third width may be substantially equal to a seventh width of the third layer 472, and the fourth width may be substantially equal to an eighth width of the fourth layer 468. The segmented stator slot 410 may include eight legs corresponding to eight conductive windings of four widths, the segmented stator slot 410 being one of a plurality of slots (such as plurality of stator slots 240 of FIG. 2) of the stator, with adjacent slots of the plurality of slots separated by rectangular stator teeth (such as stator teeth 250 of FIG. 2).

In this way, utilizing layers within a stator slot of differing widths, DC resistance of rectangular hairpin wires within a stator of an electric motor may be reduced as compared to rectangular hairpin wires within a conventional rectangular stator slot, and as compared to round wires within a trapezoidal slot. The technical effect of increasing the width of the layers of the stator slot outward along a radial direction of the stator is that an approximately constant magnetic flux within stator teeth between adjacent slots may be maintained, increasing efficiency of the electric motor. Further, the slot area may be increased as compared to a rectangular stator slot for a given outer diameter of an electric motor, thereby reducing the amount of iron of a stator tooth while maintaining the same total magnetic flux per stator tooth. This design may therefore increase the magnetic flux density per stator tooth as compared to the conventional rectangular stator slot design. Additionally, the filling factor of this design may be greater than that of round wires in a trapezoidal stator slot and the same as hairpin wires within a rectangular stator slot, thereby increasing power density of the electric motor. Finally, by using hairpin wires, manufacturing of the electric motor may be simplified as compared to the insertion of round wires within a trapezoidal slot.

The disclosure provides support for a system for a stator assembly of an electric motor, comprising: a plurality of segmented slots positioned around an inner cylindrical surface of the stator, and a plurality of hairpin wires of different widths stacked within each of the segmented slots. In a first example of the system, each of the segmented slots includes two or more layers with each layer housing one or more legs of one or more corresponding hairpin wires. In a second example of the system, optionally including the first example, a first width of a first layer of the two or more layers is less than a second width of a second layer of the two or more layers, the first layer proximal to the inner cylindrical surface of the stator. In a third example of the system, optionally including one or both of the first and second examples, the two or more layers includes four layers, wherein a third width of a third layer of the two or more layers is less than the second width, and wherein a fourth width of a fourth layer of the two or more layers is less than the third width. In a fourth example of the system, optionally including one or more or each of the first through third examples, the fourth layer is proximal to a rotor of the electric motor, wherein the third layer is adjacent to the fourth layer, wherein the second layer is adjacent to the third layer, and wherein the first layer is adjacent to the second layer. In a fifth example of the system, optionally including one or more or each of the first through fourth examples, each of the first layer, the second layer, the third layer, and the fourth layer housing at least two legs of two corresponding hairpin wires. In a sixth example of the system, optionally including one or more or each of the first through fifth examples, the plurality of hairpin wires includes a first set of hairpin wires of a fifth width with one leg of each of the hairpin wires of the first set inserted within the first layer, and a second set of hairpin wires of a sixth width with one leg of each of the hairpin wires of the second set inserted within the second layer. In a seventh example of the system, optionally including one or more or each of the first through sixth examples, the plurality of hairpin wires further includes a third set of hairpin wires of a seventh width with one leg of each of the hairpin wires of the first set inserted within the third layer, and a fourth set of hairpin wires of an eighth width with one leg of each of the hairpin wires of the second set inserted within the fourth layer. In an eighth example of the system, optionally including one or more or each of the first through seventh examples, each of the first set, the second set, the third set, and the fourth set includes two hairpin wires. In a ninth example of the system, optionally including one or more or each of the first through eighth examples, the fifth width is less than the sixth width, wherein the sixth width is less than the seventh width, and wherein the seventh width is less than the eighth width. In a tenth example of the system, optionally including one or more or each of the first through ninth examples, the first width is substantially equal to the fifth width, wherein the second width is substantially equal to the sixth width, wherein the third width is substantially equal to the seventh width, and wherein the fourth width is substantially equal to the eighth width.

The disclosure also provides support for a system for conductive windings for a stator of an electric motor, comprising: a first set of conductive windings of a first width inserted within a first layer of a slot positioned along an inner surface the stator, and a second set of conductive windings of a second width inserted within a second layer of the slot, the second width greater than the first width. In a first example of the system, the slot is segmented in shape with a width of the slot diverging from a first end proximal to a rotor to a second end proximal to a housing of the electric motor. In a second example of the system, optionally including the first example, the system further comprises: a third set of conductive windings of a third width inserted within a third layer of the slot positioned adjacent to the second layer, and a fourth set of conductive windings of a fourth width inserted within a fourth layer of the slot positioned adjacent to the third layer, the third width greater than the second width and the fourth width greater than the third width. In a third example of the system, optionally including one or both of the first and second examples, each of the first set, the second set, the third set, and the fourth set of conductive windings includes one leg each of corresponding two conductive windings of a same width. In a fourth example of the system, optionally including one or more or each of the first through third examples, the slot includes eight legs corresponding to eight conductive windings of four widths. In a fifth example of the system, optionally including one or more or each of the first through fourth examples, the slot is one of a plurality of slots of the stator, and wherein adjacent slots of the plurality of slots are separated by rectangular stator teeth.

The disclosure also provides support for a system for conductive windings for a stator of an electric motor, comprising: a plurality of radial slots evenly spaced circumferentially around an inner cylindrical surface with each slot diverging from the inner cylindrical surface of the stator towards an outer cylindrical surface of the stator, and conductive windings of varying widths inserted within each radial slot. In a first example of the system, each radial slot includes four sets of conductive windings with a width of the conductive windings increasing from a first end of the radial slot proximal to the inner cylindrical surface of the stator towards a second end of the radial slot proximal to the outer cylindrical surface of the stator. In a second example of the system, optionally including the first example, each set of conductive windings includes two conductive windings of same dimensions.

FIGS. 2-4B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Note that the example control and estimation routines included herein can be used with various electric motor and/or vehicle system configurations. The control methods and routines disclosed herein may be stored as executable instructions in non-transitory memory and may be carried out by the control system including the controller in combination with the various sensors, actuators, and other electric motor hardware. The specific routines described herein may represent one or more of any number of processing strategies such as event-driven, interrupt-driven, multi-tasking multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the electric motor control system, where the described actions are carried out by executing the instructions in a system including the various electric motor hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to various types of electric motors. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for a stator assembly of an electric motor, comprising:
a plurality of segmented slots positioned around an inner cylindrical surface of the stator; and
a plurality of hairpin wires of different widths stacked within each of the segmented slots.

2. The system of claim 1, wherein each of the segmented slots includes two or more layers with each layer housing one or more legs of one or more corresponding hairpin wires.

3. The system of claim 2, wherein a first width of a first layer of the two or more layers is less than a second width of a second layer of the two or more layers, the first layer proximal to the inner cylindrical surface of the stator.

4. The system of claim 3, wherein the two or more layers includes four layers, wherein a third width of a third layer of the two or more layers is less than the second width, and wherein a fourth width of a fourth layer of the two or more layers is less than the third width.

5. The system of claim 4, wherein the fourth layer is proximal to a rotor of the electric motor, wherein the third layer is adjacent to the fourth layer, wherein the second layer is adjacent to the third layer, and wherein the first layer is adjacent to the second layer.

6. The system of claim 5, wherein each of the first layer, the second layer, the third layer, and the fourth layer housing at least two legs of two corresponding hairpin wires.

7. The system of claim 4, wherein the plurality of hairpin wires includes a first set of hairpin wires of a fifth width with one leg of each of the hairpin wires of the first set inserted within the first layer, and a second set of hairpin wires of a sixth width with one leg of each of the hairpin wires of the second set inserted within the second layer.

8. The system of claim 7, wherein the plurality of hairpin wires further includes a third set of hairpin wires of a seventh width with one leg of each of the hairpin wires of the first set inserted within the third layer, and a fourth set of hairpin wires of an eighth width with one leg of each of the hairpin wires of the second set inserted within the fourth layer.

9. The system of claim 8, wherein each of the first set, the second set, the third set, and the fourth set includes two hairpin wires.

10. The system of claim 8, wherein the fifth width is less than the sixth width, wherein the sixth width is less than the seventh width, and wherein the seventh width is less than the eighth width.

11. The system of claim 10, wherein the first width is substantially equal to the fifth width, wherein the second width is substantially equal to the sixth width, wherein the third width is substantially equal to the seventh width, and wherein the fourth width is substantially equal to the eighth width.

12. A system for conductive windings for a stator of an electric motor, comprising:
a first set of conductive windings of a first width inserted within a first layer of a slot positioned along an inner surface the stator; and
a second set of conductive windings of a second width inserted within a second layer of the slot, the second width greater than the first width.

13. The system of claim 12, wherein the slot is segmented in shape with a width of the slot diverging from a first end proximal to a rotor to a second end proximal to a housing of the electric motor.

14. The system of claim 12, further comprising, a third set of conductive windings of a third width inserted within a third layer of the slot positioned adjacent to the second layer, and a fourth set of conductive windings of a fourth width inserted within a fourth layer of the slot positioned adjacent to the third layer, the third width greater than the second width and the fourth width greater than the third width.

15. The system of claim 14, wherein each of the first set, the second set, the third set, and the fourth set of conductive windings includes one leg each of corresponding two conductive windings of a same width.

16. The system of claim 12, wherein the slot includes eight legs corresponding to eight conductive windings of four widths.

17. The system of claim 12, wherein the slot is one of a plurality of slots of the stator, and wherein adjacent slots of the plurality of slots are separated by rectangular stator teeth.

18. A system for conductive windings for a stator of an electric motor, comprising:
a plurality of radial slots evenly spaced circumferentially around an inner cylindrical surface with each slot diverging from the inner cylindrical surface of the stator towards an outer cylindrical surface of the stator; and
conductive windings of varying widths inserted within each radial slot.

19. The system of claim 18, wherein each radial slot includes four sets of conductive windings with a width of the conductive windings increasing from a first end of the radial slot proximal to the inner cylindrical surface of the stator towards a second end of the radial slot proximal to the outer cylindrical surface of the stator.

20. The system of claim 18, wherein each set of conductive windings includes two conductive windings of same dimensions.
